(19) United States
(12) Patent Application Publication
(10) Pub. No.: US 2010/0319262 A1
(43) Pub. Date: Dec. 23, 2010

(54) POWERED GATE

(76) Inventor: Edward J. Stull, Oxford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/864,712

(22) PCT Filed: Jan. 30, 2009
(86) PCT No.: PCT/US09/32538

§ 371 Date: Jul. 27, 2010

Related U.S. Application Data
(60) Provisional application No. 61/024,605, filed on Jan. 30, 2008.

(51) Int. Cl. E05F 15/02; E06B 11/02

(52) U.S. Cl. 49/348; 49/358

(57) ABSTRACT

A disclosed example powered gate assembly includes an actuator disposed within a post integral to the gate assembly. The post also includes a drive mechanism for moving the gate assembly between open and closed positions. The actuator and drive mechanism are completely disposed within the gate. The integral construction of the first post and therein the actuator provides a substantially complete automated gate assembly that is ready for installation. The actuator and drive mechanism are disposed within a post of the gate assembly and therefore are protected from the elements and undesired tampering.

### CROSS REFERENCE TO RELATED APPLICATION

The application claims priority to U.S. Provisional Application No. 61/024,605, which was filed on Jan. 30, 2008.

### BACKGROUND OF THE INVENTION

This invention generally relates to powered gate. More particularly, this disclosure relates to a powered gate including an integral actuator and mounting means.

A powered gate is typically constructed by attaching a drive arm or device to an existing gate assembly. In this way, any regular manually opened and closed gate can be utilized. Disadvantageously, such aftermarket and retrofitted opening devices are not aesthetically pleasing. Further and even more problematic is the difficulty in making a universal gate opener work properly with gates built and designed without consideration of being opened automatically. Additionally, the exposed parts of the gate opening device are susceptible to the elements and purposeful damage that each can render the gate inoperable.

Accordingly, it is desirable to design and build a powered gate that addresses such deficiencies.

### SUMMARY OF THE INVENTION

A disclosed example powered gate assembly includes an actuator disposed within a post integral to the gate assembly. The post also includes a drive mechanism for moving the gate assembly between open and closed positions.

The actuator is completely disposed within the gate assembly. The drive mechanism includes an internal post that remains stationary relative to the first post of the gate assembly. The first post is an integral portion of the gate assembly and therefore, the actuator is also an integral feature of the gate assembly such that no moving parts are disposed outside of the gate assembly. The integral actuator is concealed within the first post and is not an added on feature or post mounted to an existing gate. The integral construction of the first post and therein the actuator provides a substantially complete automated gate assembly that is ready for installation. Because the actuator and drive mechanism are all disposed within the first post, they are not readily accessible, and therefore are protected from the elements and undesired tampering.

These and other features of the present invention can be best understood from the following specification and drawings, the following of which is a brief description.

### BRIEF DESCRIPTION OF THE DRAWINGS

FIG. 1 is a perspective view of an example powered gate assembly.

FIG. 2 is a partial cross-sectional view of the example gate assembly.

FIG. 3 is a cross-sectional view of a post of the gate assembly including an example powered actuator.

FIG. 4 is a side view of an example mounting journal.

FIG. 5 is a top view of the example mounting journal.

FIG. 6 is a cross-sectional view of the example drive mechanism.

FIG. 7 is another partial cross-sectional view of the example drive mechanism.

### DETAILED DESCRIPTION OF THE PREFERRED EMBODIMENT

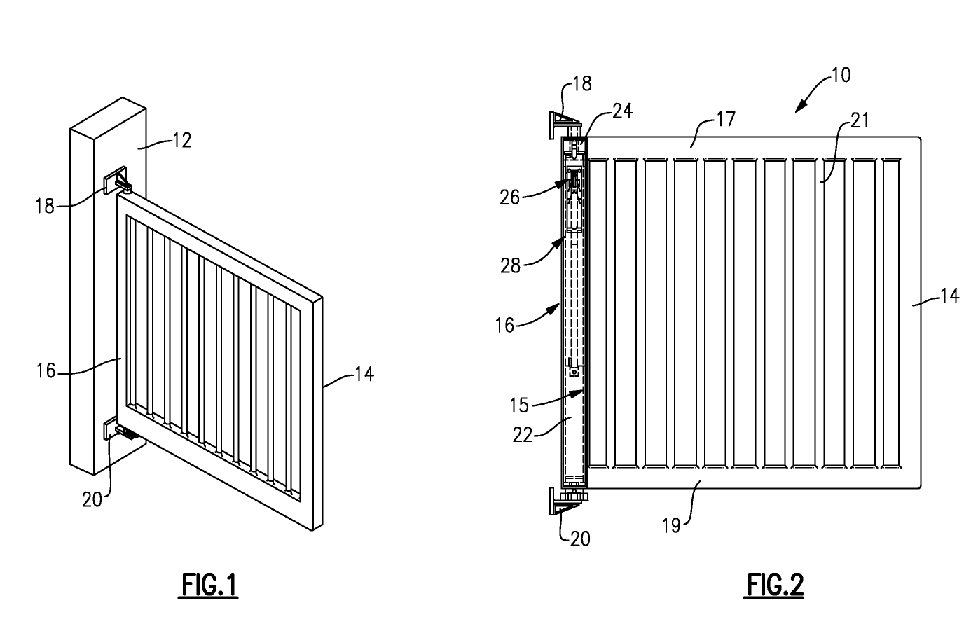

Referring to FIGS. 1 and 2, an example powered gate assembly 10 is mounted to a fixed structure 12 such as for example an end post or a fence. The gate assembly 10 includes a first post 16 and a second post 14 that are spaced apart by a top and bottom rails 17, 19. A plurality of vertical rails 21 extends between the top and bottom rails 17 and 19. As appreciated, the example gate assembly 10 is only one of many known configurations including rails and posts to extend across an opening to control access. The first post 16 is secured to the fixed structure 12 by a top mounting bracket 18 and a bottom mounting bracket 20.

An actuator 22 is disposed within the first post 16 and includes a drive mechanism 28 for swinging the gate assembly 10 between open and closed positions. The drive mechanism 28 includes a support bearing 26 that supports and provides for rotation of the gate assembly 10.

The actuator 22 is completely disposed within the gate assembly 10. The drive mechanism 28 includes an internal post 15 that remains stationary relative to the first post 16 of the gate assembly 10. The example first post 16 defines an open space within which is disposed both the internal post 15 and the actuator 22. The first post 16 is an integral portion of the gate assembly 10 and therefore, the actuator 22 is also an integral feature of the gate assembly 10. There are no moving parts external to the gate assembly 10.

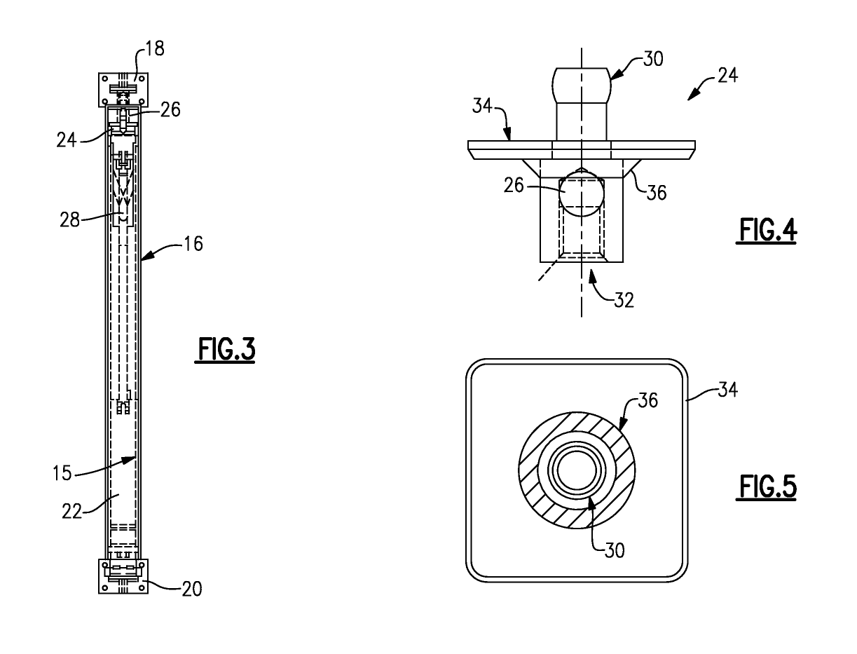

Referring to FIGS. 3, 4 and 5, the first post 16 includes the actuator 22 that drives the drive mechanism 28 disposed within the inner fixed post 15. The support bearing 26 is mounted atop the fixed inner post 15 and supports the first post 16. The first post 16 rotates on the support bearing 26 to provide for the desired rotation of the gate assembly 10.

The first post 16 includes a top mounting journal 24 that fits within the top bracket 18. The journal 24 includes a post 30 with a semi-spherical element that engages the mounting bracket 18 to provide a contact point that allows for adjustment and alignment of the gate assembly 10 within the gate opening. The journal 24 is fixed to the first post 16 and includes a bore 32 within which is supported the support bearing 26. The support bearing 26 rests on the fixed inner post 15 and the journal 24 is in turn supported on the journal 24. The journal includes a flange 34 that facilitates attachment to the first post 16. The flange 34 is secured to the post 30 and the bore portion 32 by a weld 36.

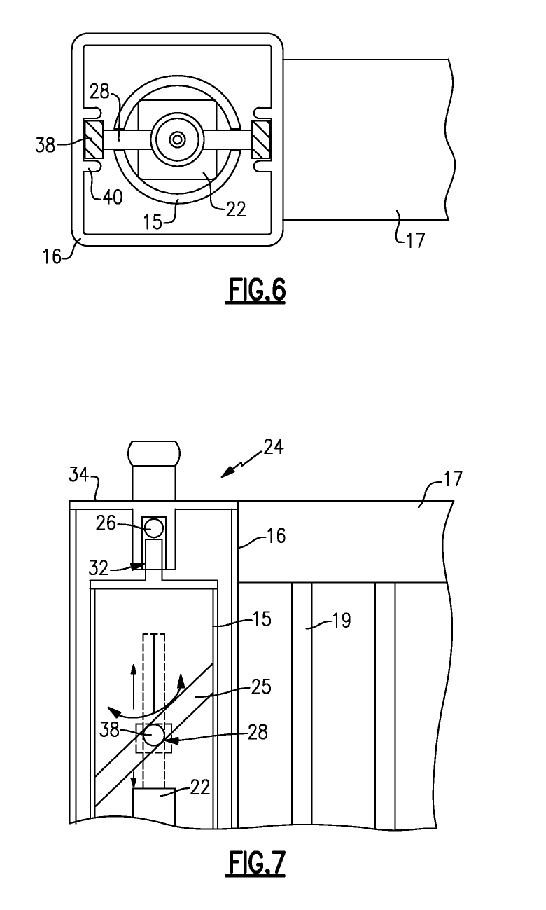

Referring to FIGS. 6 and 7, the example actuator 22 moves in a linear direction vertically within the inner post 15. The vertical movement of the actuator 22 is transferred to rotational movement by the drive mechanism 28. The example drive mechanism includes a bearing 38 that guides within slots 40 defined within the outer post 16. The inner post 22 includes slots 25 shaped so as to translate the vertical movement of the actuator 22 and drive mechanism 28 into rotational movement. These drive features are all disposed within the first post 16 and are not readily accessible, and therefore are protected from the elements and undesired tampering.

The example gate assembly 10 includes an integral actuator 10 concealed within the first post 16. The post 16 is an integral part of the gate assembly 10 and is not an added on feature or post mounted to an existing gate. The post 16 provides structure to the gate assembly 10. The integral construction of the first post 16 and therein the actuator 22 provides a substantially complete automated gate assembly that is ready for installation.

Although a preferred embodiment of this invention has been disclosed, a worker of ordinary skill in this art would recognize that certain modifications would come within the scope of this invention. For that reason, the following claims should be studied to determine the true scope and content of this invention.

1. A powered gate assembly comprising:
a first post and a second post separated a horizontal distance by at least one intermediate cross-member; and
an actuator disposed within the first post, the actuator providing for movement of the gate assembly between an open and closed position.

2. The assembly as recited in claim 1, wherein the first post defines an open internal space and the actuator is disposed within that internal space.

3. The assembly as recited in claim 1, including an inner fixed post disposed within the first post, wherein the actuator is disposed within the fixed post and rotates the first post relative to the inner fixed post.

4. The assembly as recited in claim 3, wherein the drive mechanism is disposed within the inner fixed post and is driven by the actuator for driving the first post about the inner fixed post.

5. The assembly as recited in claim 3, including a support bearing mounted to the inner fixed post for supporting movement of the first post relative to the inner fixed post.

6. The assembly as recited in claim 5, wherein the support bearing includes a ball bearing disposed within a cavity and the inner fixed post includes a portion received within the cavity such that the first post is supported atop the ball bearing that is in turn supported atop the inner fixed post.

7. The assembly as recited in claim 1, including a top mounting bracket mountable to a fixed support, wherein the first post includes a mounting journal receivable within the top mounting bracket for supporting the gate assembly relative to a fixed support.

8. The assembly as recited in claim 7, including a bottom mounting bracket mountable to a fixed support, wherein the first post includes a bottom journal member receivable within the bottom mounting bracket.

9. The assembly as recited in claim 1, wherein the mounting journal includes a cavity within which is received a ball bearing for supporting the first post on the inner fixed post.

10. A powered gate assembly comprising:
a movable structure for extending across an opening;
a cavity defined within the movable structure; and
an actuator mounted within the cavity for moving the movable structure relative to the opening.

11. The assembly as recited in claim 10, including an inner post disposed within the cavity and fixed relative to the movable structure, wherein the actuator is mounted to the inner post.

12. The assembly as recited in claim 11, including a drive mechanism driven by the actuator for moving the movable structure relative to the inner post.

13. The assembly as recited in claim 12, including a bottom support bracket for supporting the inner post relative.

14. The assembly as recited in claim 13, including a top support bracket mountable to a fixed structure and the movable structure including a mounting journal received within the top support bracket.

15. The assembly as recited in claim 10 wherein the actuator comprises a motor that moves an element of the drive mechanism linearly and the drive mechanism corresponds with a portion of the inner post to rotate the movable structure.
